(19) United States
(12) Patent Application Publication
(10) Pub. No.: US 2018/0341984 A1
(43) Pub. Date: Nov. 29, 2018

(54) Systems and methods for high-relevancy online advertising via consumer-initiated computer communications between a business and a consumer

(71) Applicant: Mr. Arthur Guberman, Freehold, NJ (US)

(72) Inventor: Arthur Guberman, Freehold, NJ (US)

(21) Appl. No.: 15/990,628

(22) Filed: May 26, 2018

Related U.S. Application Data
(60) Provisional application No. 62/511,422, filed on May 26, 2017.

(51) Int. Cl. G06Q 30/02; G06F 3/0481; G06F 3/0482

(52) U.S. Cl. CPC G06Q 30/0257; G06F 3/04817; H04L 67/42; G06Q 30/0233; G06F 3/0482

(57) ABSTRACT

The invention relates to a computer application that allows a consumer to recreate his/her community of favorite business from around town and around the world on a computer platform by selecting, on a virtual map, businesses of interest to the consumer, and thereby allows direct communication over a computer network between the selected businesses and the consumer. The consumer interacts with this virtual world through an engaging graphical interface containing icons that depict each business as a uniquely represented, three-dimensional building. Once the consumer creates and account and selects the business on the map, the business can gain real-time access to the consumer through the application delivering highly relevant marketing material to the consumer who had initiated the interaction. The application also provides for a unique reward system for users of the platform.

### CROSS-REFERENCE

This application claims the benefit of a provisional application, Application No. 62/511,422, filed on May 26, 2017.

### FIELD OF THE INVENTION

The invention relates to the field of virtual reality and social media platforms. More particularly, the invention relates to the field of real-time and high-relevance marketing of businesses to consumers on a social media platform.

### BACKGROUND OF THE INVENTION

Recent technological advances in the mobile space allow communications between brick-and-mortar businesses and consumers via social media advertising, emails, texts, etc. Such communications are typically not performed in real time and instead are executed in bulk using static customer lists via third-party service providers.

When businesses wish to contact consumers in real time, their options are limited. Social media platforms, such as Facebook® and Twitter®, offer businesses a virtual presence where general consumer-facing messaging can be updated on a business's social media page or via a specific business hashtag, where the consumer “follows” such business or where consumers receive targeted advertising based on consumer activity. However, such messaging is generally hidden or lost amidst myriad social update feeds focused on friends and news, and any business-related messaging that does come through is often seen by the consumer as a nuisance.

A business can send consumers notifications and promotions through its own webpage or its proprietary mobile application (“app”). However, the webpage-based marketing requires consumers to be proactive and visit the webpage to learn of the advertisements. The proprietary apps fail to effectively reach potential customers, would be cost-prohibitive for most small businesses to develop and implement, and is unlikely to gain widespread adoption due to the sheer number of apps that the consumer would need to download to represent all—or even a significant fraction—of the businesses of interest to him/her.

Businesses also can call, text or email customers directly if they have updated customer contact information though it would require significant cost and effort to maintain their own customer databases. Moreover, the usual outcome of such marketing approaches is that the consumer does not timely read these communications, the consumer gets annoyed by the bombardment and repetitiveness of these communications across multiple channels, the consumer is reluctant to provide contact information and thus is not alerted to the communication (for example, it was directed to the spam folder or to rarely used email addresses), and/or the consumer becomes overwhelmed by the volume of low-relevancy communications. Furthermore, these approaches fail to effectively reach potential customers.

### SUMMARY OF THE INVENTION

The systems and methods described herein improve on the low relevancy of internet marketing campaigns by giving businesses and other organizations the capability for real-time marketing in a manner that is highly relevant to the targeted consumers. They provide a visually-appealing, game-like computer platform such as a mobile app that consumers can use to search for businesses of interest—from brick-and-mortar neighborhood stores or regional sports venues to national hotel brands or virtual businesses in the cloud—and initiate contact with the businesses thereby allowing the businesses to market in real time directly to the consumer who already indicated that the marketing would be highly relevant to him/her. Via the platform, the consumer can create and maintain a visually appealing, easily accessible collection of favorite businesses and a real-time feed of their current promotions and even solicit personalized offers from them.

Upon selecting a business of interest displayed on the platform, the business is added as a unique icon to the consumer's vibrant, game-like virtual community, such as, for example, to a simulation of his/her town having multiple unique icons representing the different neighborhood businesses that the user patronizes. The consumer creates an account within the platform so that businesses can communicate directly with the consumer in real time about products and services virtually guaranteed to be relevant to the consumer.

In one embodiment of the invention, the platform provides improved systems and methods for businesses to communicate directly with consumers, including displaying a game-like map of a virtual community created and defined by the consumer, displaying visually appealing icons on the map in which each icon represents a different business of interest to the consumer. (As used throughout, the term “including” means including without limitation). The virtual community is created upon the consumer selecting one or more icons to place in the community, establishing communication between the consumer and these businesses at the request of the consumer. Subsequent selection of an icon in the virtual community may also include further communications between the business represented by the icon and the consumer. In this manner, the consumer essentially requests highly relevant marketing information from businesses that the consumer is interested in.

In another embodiment of the invention, the new social media platform provides a system for communicating messages from business to consumers that includes a server coupled to a network that is configured to: communicate over the network with a client which is configured to display maps and icons and receive communications, relay to the client mapping information of a map of a virtual community created and defined by the consumer, relay to the client icons capable of being displayed on the map, in which each icon represents a different business in which the consumer has expressed interest, relay to the client the selection of icons by the consumer, and relay to the client communications from these businesses at the request of the consumer. For example, businesses and consumers can take advantage of this system by downloading a computer application providing the platform, such as a mobile app, for delivering highly relevant marketing information from businesses to customers and potential customers.

In yet another embodiment of the invention, the platform is provided on a device, such as a smart phone, including a computer-readable medium containing executable instructions that cause a map of a virtual community created and defined by a consumer to be displayed, icons to be shown on the map in which each icon represents a business of interest to the consumer, the consumer's selection of icons to be displayed, and communication to be established between the consumer and the business.

In a further embodiment of the invention, the communication sent from the business to the consumer includes marketing information. The communication may be in the form of a message, notification, event and/or graphic image.

In a further embodiment, the communication between the business and the consumer is in real time. The real-time nature of the business's advertising can be particularly useful when, for example, the consumer is in the nearby vicinity of a business such that the advertising may entice the consumer into the store.

In a further embodiment of the invention, the systems and methods described herein can deliver advertising at high levels of relevance well beyond the norms observed in online marketing efforts by reference to any metric, such as click-through rate and conversion rate, that is used to measure advertising relevance. For example, the business's marketing information may have between 90% and 100% relevance to the consumer.

In a further embodiment of the invention, through the platform, the consumer opens an account with an intermediary between the business and the consumer. In one embodiment, the account with the intermediary is created by the consumer before the first business of interest is identified. The consumer may identify the business of interest by selecting, on the map, the respective icon associated with the business.

In a further embodiment of the invention, through the platform, the business opens an account with an intermediary between the business and the consumer. The account with the intermediary may be created by the business before the consumer selects on the map the icon representing the business when the consumer creates and defines his/her virtual community.

In another embodiment of the invention, the consumer can earn or qualify for rewards and/or promotions. The rewards and promotions can be delivered to the consumer via, for example, a mobile app and redeemed in the physical store. The consumer can enter a request into the platform to redeem earned points. The points, which can be earned by activity with any of the icons of the consumer's virtual world, can be redeemed for cash value from an intermediary between the consumer and the business for use at that, or any other, business. The redemption can be performed using a QR code that is generated by the intermediary.

### BRIEF DESCRIPTION OF THE DRAWINGS

FIG. 1 is a flowchart of an exemplary selection process of a business by a user/consumer, in accordance with an embodiment of the invention.

FIG. 2 is an exemplary flowchart of a process for creating a community by a user/consumer in accordance with an embodiment of the invention.

FIG. 3 is a screenshot of a first exemplary user interface by which a user/consumer can view a business that the user/consumer has identified and selected as a business of interest, in accordance with an embodiment of the invention.

FIG. 4 is screenshot of a second exemplary user interface by which a user/consumer can view a business that the user/consumer has identified and selected as a business of interest, in accordance with an embodiment of the invention.

FIG. 5 is a diagram of an exemplary way for a user/consumer to initiate communication with a business in order to allow the business to send electronic marketing messages to the user/consumer, in accordance with an embodiment of the invention.

FIG. 6 is a diagram of an exemplary way for a user/consumer to redeem reward points earned using the platform, in accordance with an embodiment of the invention.

FIG. 7 is an exemplary flowchart of a process of a reward system in accordance with an embodiment of the invention.

### DETAILED DESCRIPTION OF THE INVENTION

The systems and methods of the present invention improve and overcome the prior art's low relevancy of online advertising by providing real-time communication between businesses and consumers that permits, via a virtual reality interface/platform, the delivery of marketing information that is highly relevant to the consumers.

The platform involves a computer application such as a mobile app that consumers can use to recreate their community, creating maps of their virtual community or world that contain, among other things, businesses of interest to the consumer. The community could span the globe or focus on their neighborhood downtown or an area of any geographic scope, contiguous or not.

Accordingly, the businesses can be brick-and-mortar businesses in the consumer's neighborhood or beyond; for example, a sports venue, government agency, network provider, news agency, theater, museum, coffee shop, store, nightclub, restaurant, bar, salon, places of worship, park, parking garage, concert venue, convention center, hospital, doctor's office, dentist office, law firm, bank, hotel, casino, police station, firehouse, airport, train station, bus terminal, taxi service, and/or gym. Alternatively, or in addition, at least one of the businesses can be a virtual entity such as a storefront in the cloud that has no brick-and-mortar place of business open to the public (for example, a particular seller on Etsy®, etc.).

The consumer interacts with this virtual community or world through, for example, a graphical interface containing icons representing businesses of interest, or potential interest, to the consumer. For example, the icons can depict each business as a uniquely three-dimensional representation of a building and/or include the business's proprietary (such as trademarked) logo, color scheme, and/or patterning. In this example, businesses of potential interest can be represented by translucent or two-dimensional icons or icons of a color different from that of icons representing businesses of interest as already identified by the consumer. An online-only business may be represented by an icon that depicts the business as an element in the cloud. A freelancer-owned business may also lack a brick-and-mortar place of business open to the public. Thus, freelancers also may be depicted in the virtual community or world as elements in the cloud or as uniquely identifiable three-dimensional representation of icons.

A virtual community or world can include other information that may be relevant to the consumer such as weather, calendar, time, news, sports, music, etc. This additional information can be based, at least in part, on the consumer's location, the consumer's profile in the application, consumer information available on the Internet, and/or the consumer's activity using the application. The consumer's profile may include demographic information, psychological profile and/or consumer profile such as address, age, gender, ethnicity, educational level, income level, marital status, occupation, religious affiliation, political affiliation, homeowner status, family size, hobbies, food interests, vices, musical talent, favorites, credit information, brand affinities, etc.

A first consumer can share his/her virtual world with a second consumer who may identify businesses of interest and add them to his/her virtual community or world. The icons of the first consumer's virtual community or world can be rendered in a manner that distinguishes them from the icons of the second consumer's virtual community or world. For example, different colors can be used for each set of icons such that when the second consumer selects an icon of the first consumer, the color of the icon changes to that of the second consumer's icons.

A consumer can, via a user interface provided by the application, invite friends to view his/her virtual community or world. Upon acceptance of the invitation, the consumer and his/her friends can share information about their businesses of interest. For example, reviews by friends of a business of interest may be highlighted or prioritized when the consumer requests reviews. In another example, a business identified in the virtual community or worlds of the consumer and his/her friends may broadcast marketing messages relevant to the group of friends, such as vacations (for example, cruises), events (for example, school events and sporting events), new exhibits (for example, museum exhibits), group sales (for example, group discounts at a theme park), etc. In another example, consumers may broadcast to friends (and vice versa) the fact that they plan to visit, are visiting or have recently visited a particular business of interest and/or that they have a pertinent coupon or promotion.

The consumer can initiate contact with businesses using the application through a variety of ways. For example, the application may send a message to the business of interest when the consumer places the respective icon on his/her virtual map. Other methods can be used by the consumer to contact the business through the application. For example, the consumer can click on the icon already placed in his/her community in a manner that activates the icon and results in requests to the business for personalized offers.

By engaging the businesses of interest to the consumer, the businesses can directly communicate with the consumer over a computer network. For example, after the consumer creates an account within the platform, such as via a mobile app, and selects a particular brick-and-mortar business on the map, the business can gain real-time access to the consumer through the platform. The communication may be directed by the business owner and/or the franchisor or even an intermediary. For example, a business may authorize an intermediary to sell items to consumers at a discount compared to prices shown on the business's website or in the brick-and-mortar store.

In an embodiment of the invention, the virtual community or world provides a platform that allows businesses to send messages to consumers. The consumer recreates his/her community by identifying, selecting, and/or defining a map of the community. The consumer places businesses of interest, represented by icons, on a map of the community. In this manner, the consumer recreates his/her virtual community or world. Other icons representing entities that are not identified by the consumer, whether or not selected by the consumer, also may be displayed in the virtual community or world. Other icons or graphics also may be displayed in the virtual community or world representing, for example, waterways, bridges, beaches, landmarks, monuments, train tracks, and/or points of reference.

Various iterations of the highly relevant marketing using the platform are contemplated. Broadly, an embodiment of the invention is a method for communicating marketing messages from a business to a user/consumer, including displaying a map of a community created and defined by the user/consumer (such as his/her town), displaying icons on the map in which each icon represents a business of interest to the user/consumer, displaying the user/consumer's selection of an icon, establishing communication between the user/consumer and the business at the request of the user/consumer, including communicating in real time the business's marketing message to the user/consumer. The user/consumer typically selects several of the icons; for example, at least 5, 10, 20, 50, 75, 100, 200, 500 or 1000 of the icons.

Another embodiment of the invention is a method for communicating marketing messages from a business to a user/consumer, including displaying a map of a community created and defined by the user/consumer, displaying icons on the map in which each icon represents a business of interest to the user/consumer, displaying the user's/consumer's selection of an icon, establishing communication between the user/consumer and the business at the request of the user/consumer, including communicating the business's marketing message that has between 90% and 100% advertising relevance to the user/consumer and/or has high levels of relevance well beyond the norms observed in online marketing efforts by reference to any metric, such as click-through rate and conversion rate, that is used to measure advertising relevance. Again, the user typically selects several of the icons.

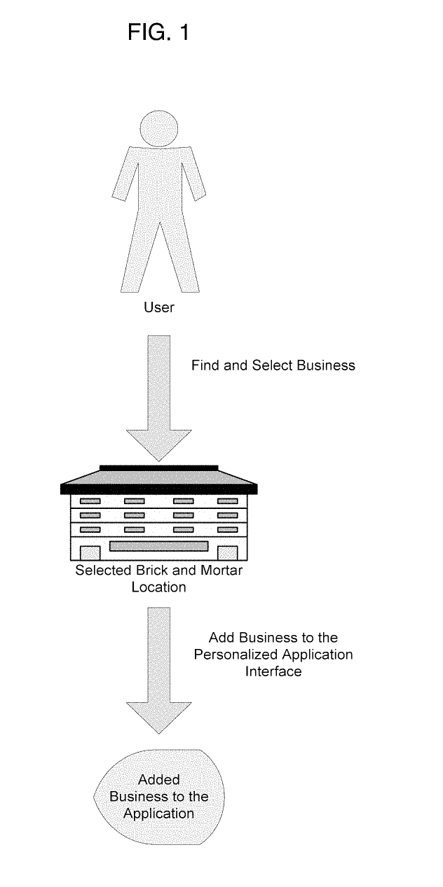

A method by which the consumer selects a business of interest for inclusion in the virtual world is set forth in FIG. 1. The consumer using the computer application such as a mobile app searches for businesses of interest in a particular community. In this example, the consumer selects a brick-and-mortar business. The consumer can be a customer or a potential customer of the business. The community can be the geographic region where the consumer resides such as a village, town, borough, city, county, state, country, etc. For clarity's sake, the community can be a local region or of worldwide scope or anything in between. The consumer can define different virtual worlds for different communities; for example, one for a hometown and another for a frequently visited city in another country. Alternatively, or in addition, the separate communities can exist within a single virtual world.

The business of interest can be identified by the consumer on a map provided by the application. The map's perspective can be overhead, angled, translucent, layered, two-dimensional, three-dimensional, and/or street level. The maps of the communities of interest to the consumer can be displayed using a proprietary mapping tool. Alternatively, or in addition, any of the many mapping services known in the art can be used such as Google Maps®, Yahoo Maps®, Windows Live Search®, MapQuest®, etc.

The business can be selected by the consumer by, for example, clicking on the icon on the map representing the business. The selected icon can be highlighted on the map, for example. Clicking on the icon may also link to any suitable source of information relating to the business such as audio, video, tours, products, services, surrounding businesses, and/or environmental information. Clicking on the icon may also, or instead, initiate communication between the consumer and the business. Different outcomes can be separated or achieved, for example, by double-clicking (or double-tapping) versus a single click/tap on an icon, or by various gesture-based movements such as swipe up/left/right, or by voice commands.

Alternatively, or in addition, consumers can identify and select a business of interest using any web browser known in the art such as Safari®, Firefox®, Google Chrome®, and Internet Explorer®. The application can operate on a consumer's device such as a personal computer whether desktop or laptop, and/or on the consumer's portable electronic device such as a smart phone, cell phone, tablet, personal digital assistant, etc. In an embodiment, the invention provides for a device such as a personal computer or a portable electronic device having a processor, a memory, a display, and a communication interface in which the device is configured to: display a map of a community created and defined by a user/consumer, display icons on the map in which each icon represents a business of interest to the user/consumer, display the user/consumer's selection of at least one icon (for example, selection of 5, 10 or 20 icons), and receive a business's marketing message to the user/consumer at the request of the user/consumer. The message may be in text and/or graphical form in any manner known in the art. The message may be received in real time or nearly so. The message may have between 90% and 100% advertising relevance to the user and/or have high levels of relevance well beyond the norms observed in online marketing efforts by reference to any metric, such as click-through rate and conversion rate, that is used to measure advertising relevance.

Alternatively, or in addition, consumers can identify and select a business of interest through the application such a mobile app by, for example, selecting a business suggested by the application as possibly being of interest to the consumer. The suggestion of a business to the consumer may be based, for example, at least in part, on the number of times the consumer has been at or near the business and/or the amount of time the consumer spent at or near the business. The location information can be based on GPS data obtained from a mobile device used by the consumer. In another example, the suggestions may be based on attributes similar businesses already selected by the consumer, for example, to identify related companies, competitors, and/or businesses providing synergistic products or services. In another example, the suggestions may be based on attributes of consumers sought by nearby businesses, for example, customers' attributes identified by businesses that have created accounts within the application.

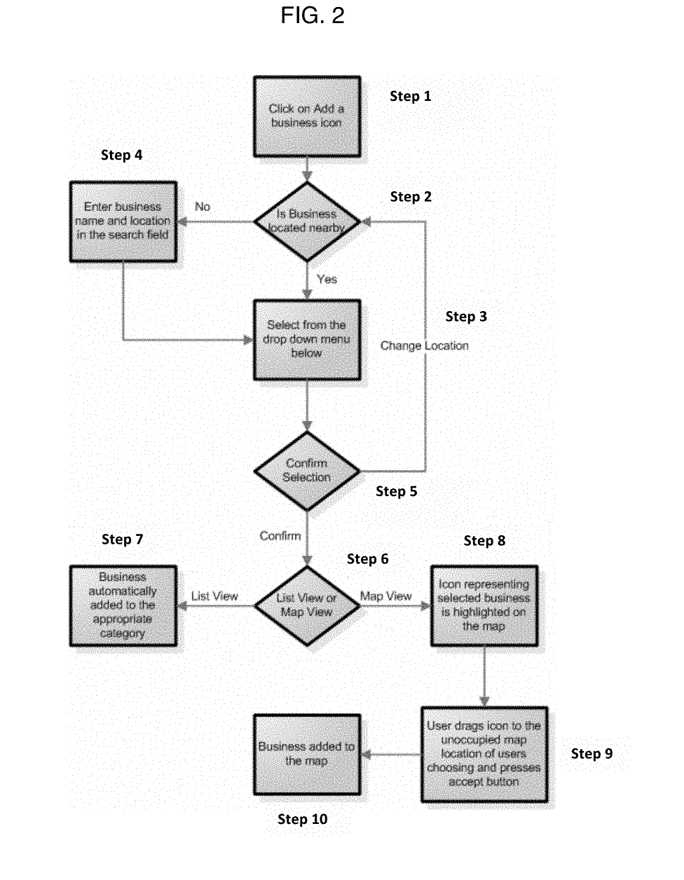

An example of steps for creating a community is shown in FIG. 2 and described as follows. A device such as a personal computer (PC) or a smart phone with the application has a screen showing an “add button.” Clicking on the add button opens a Google search screen (step 1). The screen contains a search field, a map with indicators of user/consumer's position and surrounding businesses. The map may also list nearby businesses (step 2). If there is one, a nearby business can be added to the map by selecting from the list (step 3), and the selection is then confirmed (step 5). If another nearby business is to be selected, the process goes back to step 2. On the other hand, a search for businesses not listed can be initiated by entering a name and/or an address, where a list is generated based on the search (step 4). A selection is made from the list that is generated (step 3) and confirmed (step 5). If more nonlisted businesses are desired, the process goes back to step 2. After the confirmation, a “list view” or a “map view” is shown on the screen (step 6). If a list view is selected, then the selected business is automatically added to the appropriate category (step 7). If a map view is selected, an icon representing the selected business is highlighted on the map (step 8). The user/consumer then drags the icon to the unoccupied location in the map of user's/consumer's choosing and presses the accept button (step 9). The business is then added to the map (step 10).

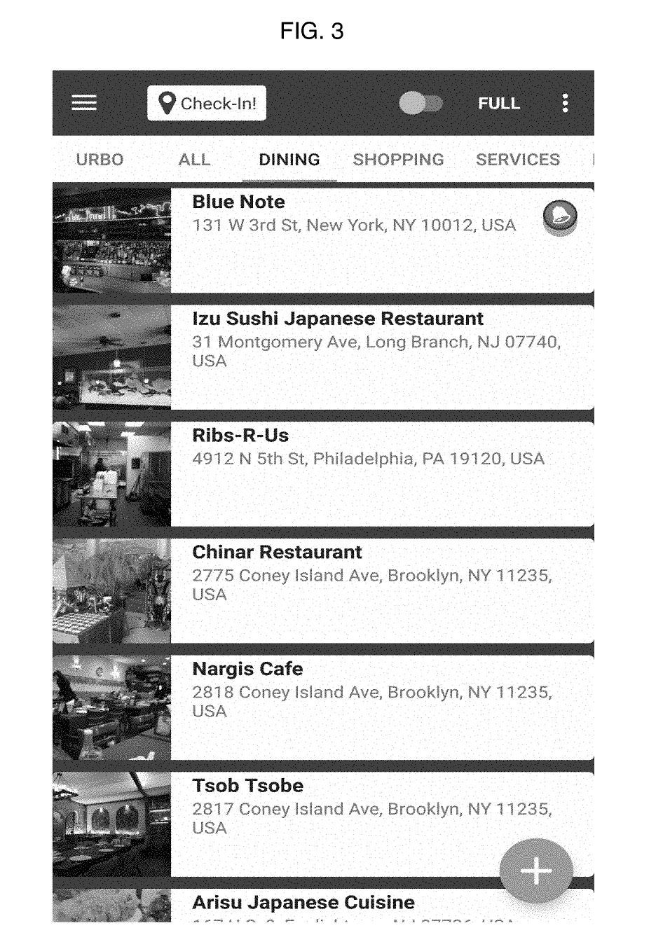

Once the consumer has identified and selected businesses of interest for inclusion into his/her virtual community or world, the businesses can be viewed in a variety of ways. For example, as shown in FIG. 3 for brick-and-mortar locations, the consumer can view the selected businesses in the form of a list. The list can identify which businesses have sent the consumer a message and/or businesses having promotions. The list can be organized into the type of business such as dining, shopping, services, etc. By clicking on a business in the list view depicted in FIG. 3, the consumer can request coupons, discounts, table reservations, custom orders, etc. Clicking on the “Check-In!” button can, for example, request real-time communication with a business.

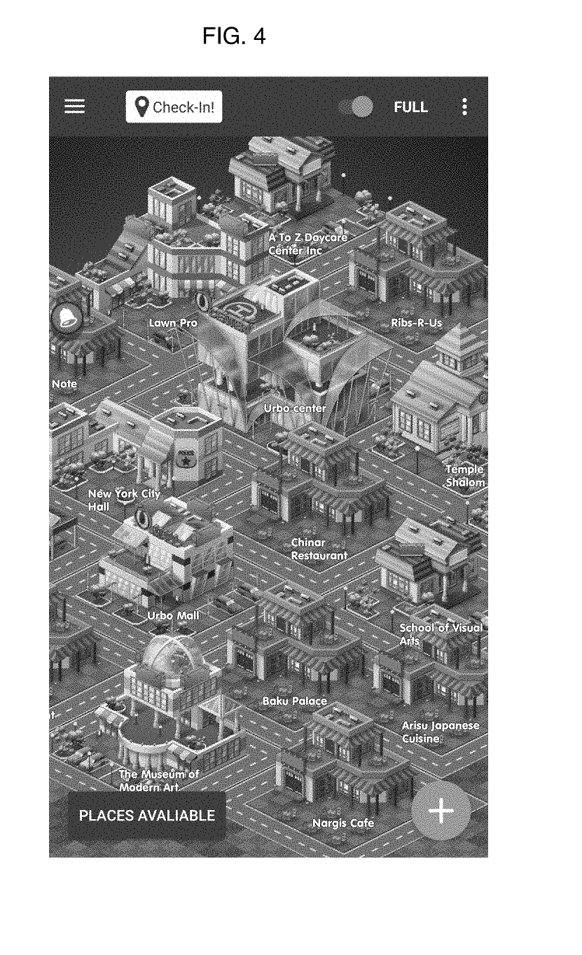

In another example, as shown in FIG. 4, the consumer can view the selected businesses on a map of his/her virtual community, in this particular example, a neighborhood within a city. The map and the icons thereon, representing the selected businesses, can be depicted as a three-dimensional representation as shown in this figure. By clicking on an icon on the map depicted in FIG. 4, the consumer can request communications from the respective business; for example, inquiring about coupons, discounts, table reservations, custom orders, etc.

As shown in FIG. 4, some of the icons (for example, those labeled “Urbo center” and “Urbo Mall”) may represent buildings and/or businesses that exist only virtually and therefore are not found as brick-and-mortar businesses. These virtual centers can, for example, enhance the user's experience in the application and/or provide a platform for the application to market to users similarly to how the other businesses on the platform can communicate marketing information to consumers. For example, the “Urbo center” may aggregate all business communications by categories, such as top deals, featured deals, popular deals, newly added deals, etc., and therefore clicking the icon can conveniently help the consumer shop for certain items across different businesses.

In another example, the “Urbo Mall” in FIG. 4 can be a destination for users to shop in a virtual mall using, for example, cash, cash equivalents, and/or rewards points earned on the platform. Items available for sale in this virtual mall can be sourced from a variety of vendors, including non-brick-and-mortar stores. The merchandise may be of a certain type of theme such as items typical of a clearance center or an outlet mall.

Although not shown in the figure, the map could include an icon representing an arcade-like destination that would allow users to play games on the platform. Another icon representing a music store could be included on the map where users can shop for and/or stream music. Many other types of icons could be included in the platform to provide a variety of goods and services in effort to enhance the user's/consumer's virtual environment and experience and to encourage users/consumers to continue using the platform.

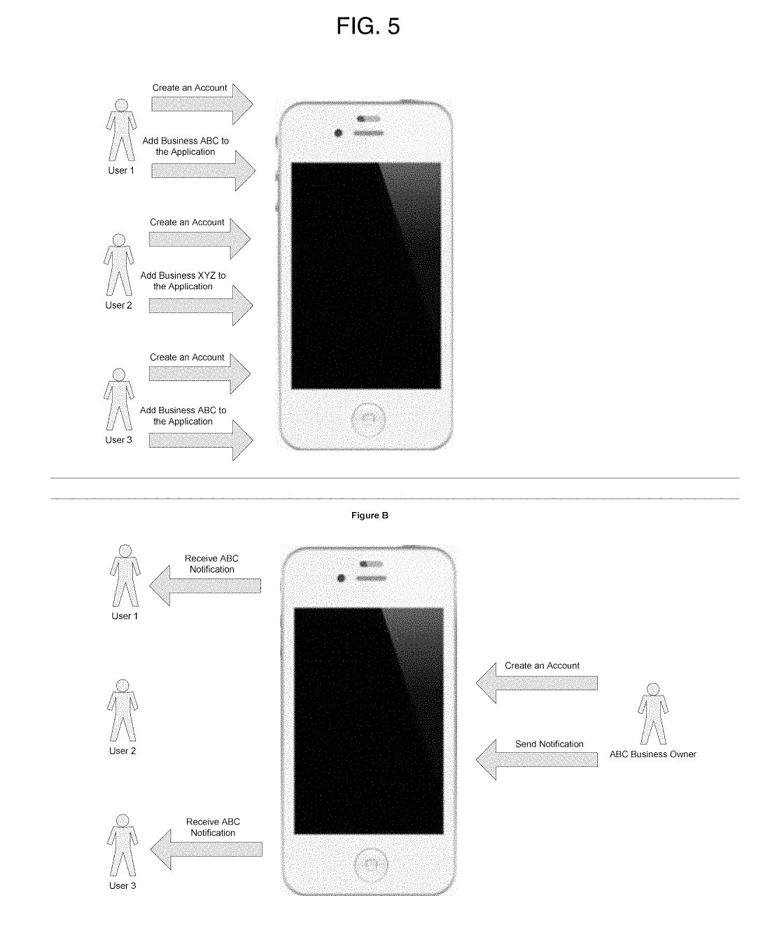

The application allows the businesses of interest to communicate with the consumer. An identified business can communicate with the consumer at the request of the consumer. The request can take on any form by which the consumer initiates the interaction, such as the consumer selecting the icon representing the business of interest, selecting the business of interest in the application by any other means, creating an account, and/or sending the business a message. For example, as shown in FIG. 5, after the consumer creates an account within the application and selects a business of interest, which is then added to the application, the consumer thereby requests communications from the business.

The initial request may occur at any point in time; for example, the application may send a message to the business of interest when the consumer completes account creation, the business completes account creation, and/or the consumer selects the business and places the respective icon on his/her virtual map. Alternatively, as the initial request, consumers may craft their own tailored messages for delivery to the businesses. The business, in turn, sends communications to the consumer about, for example, the business's products and/or services relevant to the consumer. The business may create an account in the application to be able to send communications to the consumer via the platform.

In another embodiment of the invention, the consumer opens an account within in the application. The account may be created by the consumer through an online sign-up process. The sign-up process may be done through the platform. Alternatively, the account may be created directly with the business or by the consumer with the assistance of a sales representative for the business or an intermediary. The account can be created before or after the consumer identifies the business of interest by selecting, on the map, the respective icon associated with the business. The business may create an account in the application to be able to send communications to the consumer.

In another embodiment of the invention, the platform provides a system for communicating messages from business to consumers that includes a server coupled to a network that is configured to: communicate over the network with a client, which is configured to display maps and icons, including selected icons, and receive the communications, relay to the client mapping information for a map of a virtual community created and defined by the consumer, relay to the client icons capable of being displayed on the map, in which each icon represents a different business of interest to the consumer, relay to the client the selection of at least one of the icons by the user, and relay to the client communications from these businesses at the request of the consumer. All of the systems described herein can be adapted to function with, for example, wearable technology such as smart glasses (for example, Google Glass®, Microsoft HoloLens® and Sony's SmartEyeGlass®).

In another embodiment of the invention, the server is comprised of a processor, a memory, and a communication interface in which the server is configured to: relay to a user/consumer mapping information for a map of a community defined by the user/consumer, relay to the user/consumer icons capable of being displayed on the map in which each icon represents a business of interest to the user/consumer, relay to the user/consumer an indication that the user/consumer selected one of the icons, and relay to the user/consumer a marketing message from the business at the request of the user/consumer. The message may be in text and/or graphical form in any manner known in the art. The message may be received in real time or nearly so. The message may have between 90% and 100% advertising relevance to the user/consumer and/or have high levels of relevance well beyond the norms observed in online marketing efforts by reference to any metric, such as click-through rate and conversion rate, that is used to measure advertising relevance.

In another embodiment of the invention, the platform is provided on a computer-readable medium containing executable instructions. When executed on a computer, it causes a map of a community defined by a consumer to be displayed, icons to be shown on the map in which each icon represents a business of interest to the consumer, and communication to be established between the consumer and the business.

In another embodiment of the invention, the communication sent from the business to the consumer includes marketing information. The communication may in the form of a message, notification, event and/or graphic image. The communication may be sent in a predefined format. The communication between the business and the consumer can occur in real time. For example, the business may send advertising images to the consumer that are displayed on billboards in real time within the consumer's map of his/her virtual community or world. “Real time” can be instantaneous or nearly so with any latency that is of little importance to the operation of the system. An example of real-time communication would be instant messaging which involves time for the computers to send/receive the text messages, the latency approximating the time required for computer processing and electronic transmission. This latency is typically barely noticeable to the user/consumer, if at all.

In another embodiment of the invention, the marketing information has at least 60%, 70%, 80%, or 90% relevance to the consumer. The marketing information may have 60% to 100%, 70% to 100%, 80% to 100%, or 90% to 100% relevance to the consumer. The marketing information may have between 90% and 100% relevance to the consumer. The relevance of the marketing information may be determined on a sample of multiple messages. The relevance of the marketing information may be determined by any of many methods known in the art for measuring advertising relevance. The advertising relevance may be based, at least in part, on metrics such as sales revenue, cost per lead, reduced churn, customer value, inbound marketing return on investment, traffic-to-lead ratio, lead-to-close ratio, customer retention rate, impression rate and/or conversion rate. For example, the number of times an advertisement is fetched from its source, i.e., the number of impressions, can be compared to the number of times the advertisement is actually clicked through to obtain further details of the promotion.

In another example, the fraction of users/consumers that click on the icon representing a certain business who make a purchase, or complete another action on the business's website (such as signing up for workshops), can serve as a useful metric for determining the relevancy of the marketing messages. Indeed, the fact that the user/consumer selected the icon representing the business for his/her virtual community already indicates the high relevance of that business's marketing messages to the user/consumer.

In another embodiment of the invention, the consumer can earn or qualify for rewards and/or promotions. The rewards and promotions can keep the consumer engaged in the platform. Rewards, for example, reward points, can be earned by the consumer through purchases made on the platform. Rewards may also be earned through a variety of non-purchase activities, such as sending referrals, completing surveys, gaming on the platform, triggering bonuses, tagging or other social media activities, etc.

For example, reward points accumulated from many activities within the application as well as from purchases made at several businesses on the platform can be redeemed in person when purchasing an item at a single brick-and-mortar store. The cash value of the redeemed reward points, amounting to the discount on the purchased item, may be deducted (at least in part) from the funds of an intermediary between the customer and the business, and not entirely from funds of the business itself. The rewards and promotions can be used in the application and/or in a physical store.

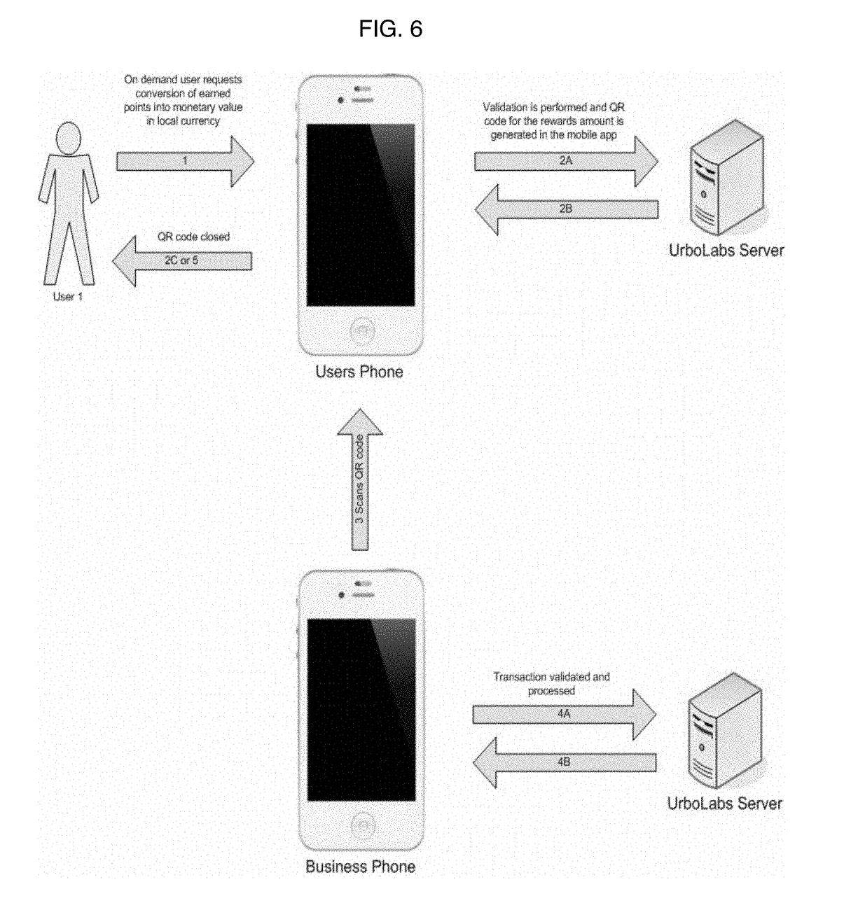

As shown in FIG. 6, the consumer can enter a request into the platform to redeem earned points. The request is relayed from the client to a server (Step 1). The request is evaluated for validation, and if validated, a QR code is generated (Step 2A). The QR code is relayed to client (Step 2B) where the QR code is closed if not valid (Step 2C). If valid, the consumer can take the QR code to a brick-and-mortar business which scans the code (Step 3). QR code is relayed to the server where the transaction is validated and processed (Step 4A). The validation is relayed from the server to the business (Step 4B). The QR code is closed (Step 5). In a further embodiment, the cash value of the earned points is redeemed by an intermediary between the consumer and the business—not by the business.

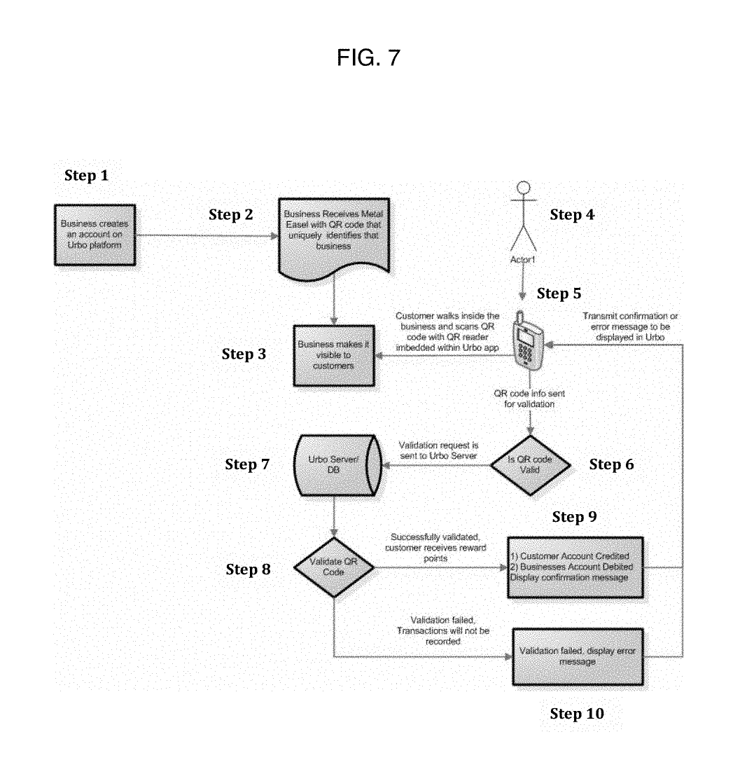

An example of how the business and the consumer participate in the reward system is further detailed in FIG. 7 and described as follows. A business signs up using an application called, for example, Urbo platform and creates an account therein (step 1). By signing, the business receives, for example, a metal easel with a QR code that uniquely identifies that business (step 2). The metal easel is made visible within the store to customers (step 3). A consumer, Actor 1, visits the physical store/business and scans the QR code using a QR reader imbedded with the application called, for example, Urbo app, on a smart phone (step 5). After scanning, the QR code information is sent for validation (step 6). The validation request is sent to a server containing a database called, for example, Urbo server, (step 7) and the request is validated or not (step 8). If the QR code information is successfully validated, then (1) the customer account is credited and (2) the business account is debited, and a confirmation message is sent to the Urbo app (step 9). If the validation fails, then an error message is sent to the Urbo app (step 10).

While the inventions have been described with respect to embodiments, and all examples presented herein are non-limiting, a person of ordinary skill in the art would appreciate that the inventions are intended to cover all modifications and equivalents within the scope of the following claims.

What is claimed is:

1. A method for communicating marketing messages from a business to a user, the method comprising:
displaying on a display of a device a map of a virtual community created and defined by the user, wherein the virtual community comprises a plurality of icons, where each icon represents a business of interest to the user;
displaying the selection of at least one of the icons by the user;
establishing communication between the user and the business at the request of the user through the selection of the icon representing the business; and
communicating an electronic marketing message from the business to the user in real time through the selection of the icon representing the business.

2. The method of claim 1 wherein the communication includes a notification, event, and/or graphical image.

3. The method of claim 1 wherein the selection of at least one of the icons by the user includes displaying the selection by the user of at least 5, 10, 20, 50 or 100 of the icons.

4. A computer-implemented method for communicating marketing messages from a business to a user, the method comprising:
displaying on a display of a device a map of a virtual community created and defined by the user, wherein the virtual community comprises a plurality of icons, where each icon represents a business of interest to the user;
displaying the selection of at least one of the icons by the user;
establishing communication between the user and the business at the request of the user through the selection of the icon representing the business; and
communicating an electronic marketing message from the business to the user in real time through the selection of the icon representing the business,
wherein the message has between 90% and 100% advertising relevance to the user.

5. The method of claim 4 wherein the communication includes a notification, event, and/or graphical image.

6. The method of claim 4 wherein the selection of at least one of the icons by the user includes displaying the selection by the user of at least 5, 10, 20, 50 or 100 of the icons.

7. A system for communicating marketing messages from a business to a user, the system comprising:
a server coupled to a network;
wherein the server is configured to:
communicate over the network with a client of a user;
relay to the client mapping information for a map of a virtual community created and defined by the user, wherein the virtual community comprises a plurality of icons, where each icon represents a business of interest to the user;
relay to the client the plurality of icons capable of being displayed on the map;
relay to the client the selection of at least one of the icons by the user;
relay to the client a communication from the business at the request of the user;
wherein the client is configured to:
display the map;
display the icons on the map;
display the selection of at least one of the icons by the user; and
receive the communication
wherein the communication includes a marketing message from the business to the user in real time through the selection of the icon by the user.

8. The system of claim 7 wherein the communication includes a notification, event, and/or graphical image.

9. The system of claim 7 wherein the message has between 90% and 100% advertising relevance to the user.

10. The system of claim 7 wherein the selection of at least one of the icons by the user includes displaying the selection by the user of at least 5, 10, 20, 50 or 100 of the icons.

11. A method of redeeming rewards points earned by a consumer using the system of claim 7, the method comprising a server:
receiving from the client a request to redeem rewards points;
evaluating the request for validation, and if validated, generating a QR code relaying the QR code to the client;
receiving the QR code scanned by a business;
processing the QR code for validation; and
relaying the validation to the business.

12. The method of claim 11 wherein the reward points comprise points earned from purchases made by the user from a plurality of businesses participating in the system, and wherein the request is to redeem the points at a single business.

13. The method of claim 12 wherein the single business is different from any of the plurality of business from which the reward points were earned.

14. A server for communicating marketing messages from a business to a user, the server comprising:
a processor;
a memory; and
a communication interface,
wherein the server is configured to:
relay to a user mapping information for a map of a virtual community created and defined by the user, wherein the virtual community comprises a plurality of icons, where each icon represents a business of interest to the user;
relay to the user the plurality of icons capable of being displayed on the map;
relay to the user an indication of the selection of at least one of the icons by the user; and
relay to the user a communication from the business at the request of the user in real time through the selection of the icon by the user,
wherein the communication includes a marketing message from the business to the user.

15. The server of claim 14 wherein the communication includes a notification, event, and/or graphical image.

16. The server of claim 14 wherein the message has between 90% and 100% advertising relevance to the user.

17. The server of claim 14 wherein the selection of at least one of the icons by the user includes displaying the selection by the user of at least 5, 10, 20, 50 or 100 of the icons.

18. A mobile communication device for communicating marketing messages from a business to a user, the device comprising:
a processor;
a memory;
a display; and
a communication interface,
wherein the device is configured to:
display a map of a virtual community created and defined by a user, wherein the virtual community comprises a plurality of icons, where each icon represents a business of interest to the user;
display the selection of at least one of the icons by the user; and
receive a communication to the user from the business at the request of the user in real time through the selection of the icon by the user,
wherein the communication includes a marketing message from the business to the user.

19. The mobile communication device of claim 18 wherein the communication includes a notification, event, and/or graphical image.

20. The mobile communication device of claim 18 wherein the message has between 90% and 100% advertising relevance to the user.
